(19) United States
(12) Patent Application Publication
(10) Pub. No.: US 2025/0072516 A1
(43) Pub. Date: Mar. 6, 2025

(54) AEROSOL GENERATING DEVICE AND OPERATING METHOD THEREOF

(71) Applicant: KT&G Corporation, Daejeon (KR)

(72) Inventors: Yong Hwan KIM, Gyeonggi-do (KR); Young Bum KWON, Gyeonggi-do (KR); Dong Sung KIM, Seoul (KR); HunII LIM, Seoul (KR); Seok Su JANG, Daejeon (KR)

(73) Assignee: KT&G Corporation, Daejeon (KR)

(21) Appl. No.: 18/564,397

(22) PCT Filed: Jun. 14, 2023
(86) PCT No.: PCT/KR2023/008207

§ 371 Date: Nov. 27, 2023

(51) Int. Cl. A24F 40/53; A24F 40/20; A24F 40/51; A24F 40/57; G01K 3/00

(52) U.S. Cl. CPC A24F 40/53; A24F 40/20; A24F 40/51; A24F 40/57; G01K 3/005

(57) ABSTRACT

An aerosol generating device according to an embodiment includes a heater configured to heat a cigarette, a temperature sensor configured to measure temperature of the heater, and a controller configured to determine a humidity state of the cigarette by calculating a temperature increase time of the cigarette by using the temperature sensor and by comparing the calculated temperature increase time of the cigarette with a preset threshold. The controller supplies power to the heater according to a basic temperature profile when the temperature increase time is less than the threshold, and supplies power to the heater according to a first correction profile when the temperature increase time is greater than or equal to the threshold.

### TECHNICAL FIELD

The present disclosure relates to an aerosol generating device and an operating method thereof. Specifically, the present disclosure relates to an aerosol generating device that may distinguish between a normal cigarette and an excessively moist cigarette on the basis of a rate of temperature increase and provide a temperature profile corresponding to a state of the cigarette, and an operating method of the aerosol generating device.

### BACKGROUND ART

Recently, the demand for a smoking method to replace normal cigarettes is increasing. For example, there is increasing demand for a method of generating an aerosol as an aerosol generating material in a cigarette is heated, rather than a method of generating an aerosol by burning a cigarette. Accordingly, research on heating-type cigarettes and heating-type aerosol generating devices is actively being conducted.

In addition, moisture has a higher specific heat than air, and has a higher heat capacity than air at the same temperature. Due to this, there may be a problem in that a user feels more heat when a user inhales an aerosol with a high moisture content, than when the user inhales air of the same temperature.

### DISCLOSURE

### Technical Problem

The present disclosure provides an aerosol generating device that may distinguish between a normal cigarette and an excessively moist cigarette and an operating method of the aerosol generating device.

The present disclosure provides an aerosol generating device including a temperature profile corresponding to each of the normal cigarette and the excessively moist cigarette, and an operating method of the aerosol generating device.

The present disclosure provides an aerosol generating device including a temperature profile corresponding to a continuous use and an operating method of the aerosol generating device.

Objects to be achieved by embodiments are not limited to the objects described above, and objects not described may be clearly understood by those skilled in the art to which the embodiments belong from the present disclosure and the accompanying drawings.

### Technical Solution

An aerosol generating device according an embodiment includes a heater configured to heat a cigarette, a temperature sensor configured to measure a temperature of the heater, and a controller configured to determine a humidity state of the cigarette by calculating a temperature increase time of the cigarette by using the temperature sensor and comparing the calculated temperature increase time of the cigarette with a preset threshold. The controller supplies power to the heater according to a basic temperature profile when the temperature increase time is less than the threshold, and supplies power to the heater according to a first correction profile when the temperature increase time is greater than or equal to the threshold.

An operating method of an aerosol generating device, according an embodiment, includes a step of heating a cigarette by using a heater, a step of measuring temperature of the heater by using a temperature sensor, a step of calculating a temperature increase time of the cigarette by using the temperature sensor and comparing the calculated temperature increase time of the cigarette with a preset threshold to determine a humidity state of the cigarette, and a step of operating the heater with a temperature profile corresponding to the determined cigarette. In the step of determining the humidity state of the cigarette, when the temperature increase time is less than the threshold, the cigarette is determined as a normal cigarette, and when the temperature increase time is greater than or equal to the threshold, the cigarette is determined as an excessively moist cigarette, and in the step of operating the heater, when the temperature increase time is less than the threshold, power is supplied to the heater according to a basic temperature profile, and when the temperature increase time is greater than or equal to the threshold, the power is supplied to the heater according to a first correction profile.

### Advantageous Effects

An aerosol generating device and an operating method thereof according to various embodiments of the present disclosure may distinguish between a normal cigarette and an excessively moist cigarette on the basis of a temperature increase time of a cigarette.

In addition, an aerosol generating device and an operating method thereof according to various embodiments of the present disclosure may provide a temperature profiles corresponding to each of a normal cigarette and an excessively moist cigarette.

In addition, an aerosol generating device and an operating method thereof according to various embodiments of the present disclosure may provide a temperature profile corresponding to a continuous use.

Effects of embodiments are not limited to the effects described above, and effects not described will be clearly understood by those skilled in the art to which the embodiments belong from the present disclosure and the accompanying drawings.

### DESCRIPTION OF DRAWINGS

FIGS. 1 to 3 are views illustrating examples in which a cigarette is inserted into an aerosol generating device.

FIGS. 4 and 5 are views illustrating examples of cigarettes.

FIG. 6 is a block diagram of an aerosol generating device according to another embodiment.

FIG. 7A is a perspective view illustrating an appearance of an aerosol generating device according to an embodiment of the present disclosure.

FIG. 7B is a perspective view illustrating an operating state in which some components are separated from the aerosol generating device according to the embodiment illustrated in FIG. 7A.

FIG. 8 is an example diagram illustrating a basic temperature profile of an aerosol generating device.

FIG. 9A is an example diagram illustrating a first correction profile of an aerosol generating device.

FIG. 9B is an example diagram illustrating a second correction profile of an aerosol generating device.

FIG. 10A is a flowchart illustrating an operating method of an aerosol generating device, according to an embodiment considering a humidity state of a cigarette.

FIG. 10B is a flowchart illustrating an operating method of an aerosol generating device, according to another embodiment considering a humidity state of a cigarette.

FIG. 11 is a flowchart illustrating an operating method of an aerosol generating device for determining whether a cigarette is continuously used.

### MODE FOR INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, embodiments of the present disclosure will be described in detail with reference to the accompanying drawings such that those skilled in the art to which the present disclosure belongs may easily implement the present disclosure. However, the present disclosure may be implemented in many different forms and is not limited to the embodiments described herein.

Hereinafter, embodiments of the present disclosure will be described in detail with reference to the drawings.

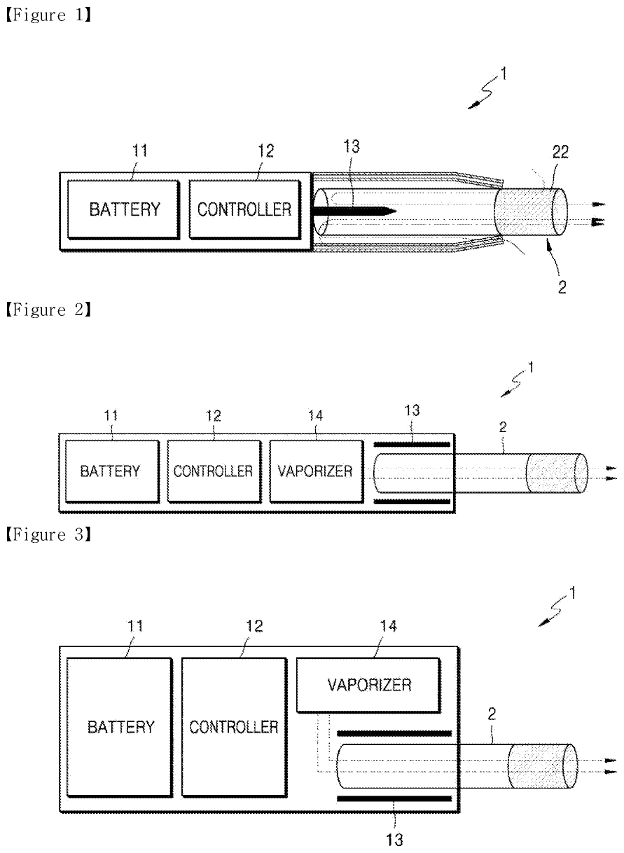

FIGS. 1 through 3 are diagrams showing examples in which a cigarette is inserted into an aerosol generating device.

Referring to FIG. 1, the aerosol generating device 1 may include a battery 11, a controller 12, and a heater 13. Referring to FIGS. 2 and 3, the aerosol generating device 1 may further include a vaporizer 14. Also, the cigarette 2 may be inserted into an inner space of the aerosol generating device 1.

FIGS. 1 through 3 illustrate components of the aerosol generating device 1, which are related to the present embodiment. Therefore, it will be understood by one of ordinary skill in the art related to the present embodiment that other general-purpose components may be further included in the aerosol generating device 1, in addition to the components illustrated in FIGS. 1 through 3.

Also, FIGS. 2 and 3 illustrate that the aerosol generating device 1 includes the heater 13. However, as necessary, the heater 13 may be omitted.

FIG. 1 illustrates that the battery 11, the controller 12, and the heater 13 are arranged in series. Also, FIG. 2 illustrates that the battery 11, the controller 12, the vaporizer 14, and the heater 13 are arranged in series. Also, FIG. 3 illustrates that the vaporizer 14 and the heater 13 are arranged in parallel. However, the internal structure of the aerosol generating device 1 is not limited to the structures illustrated in FIGS. 1 through 3. In other words, according to the design of the aerosol generating device 1, the battery 11, the controller 12, the heater 13, and the vaporizer 14 may be differently arranged.

When the cigarette 2 is inserted into the aerosol generating device 1, the aerosol generating device 1 may operate the heater 13 and/or the vaporizer 14 to generate aerosol from the cigarette 2 and/or the vaporizer 14. The aerosol generated by the heater 13 and/or the vaporizer 14 is delivered to a user by passing through the cigarette 2.

As necessary, even when the cigarette 2 is not inserted into the aerosol generating device 1, the aerosol generating device 1 may heat the heater 13.

The battery 11 may supply power to be used for the aerosol generating device 1 to operate. For example, the battery 11 may supply power to heat the heater 13 or the vaporizer 14, and may supply power for operating the controller 12. Also, the battery 11 may supply power for operations of a display, a sensor, a motor, etc. mounted in the aerosol generating device 1.

The controller 12 may generally control operations of the aerosol generating device 1. In detail, the controller 12 may control not only operations of the battery 11, the heater 13, and the vaporizer 14, but also operations of other components included in the aerosol generating device 1. Also, the controller 12 may check a state of each of the components of the aerosol generating device 1 to determine whether or not the aerosol generating device 1 is able to operate.

The controller 12 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 may be heated by the power supplied from the battery 11. For example, when the cigarette is inserted into the aerosol generating device 1, the heater 13 may be located outside the cigarette. Thus, the heated heater 13 may increase a temperature of an aerosol generating material in the cigarette.

The heater 13 may include an electro-resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set as a temperature desired by a user.

As another example, the heater 13 may include an induction heater. In detail, the heater 13 may include an electrically conductive coil for heating a cigarette in an induction heating method, and the cigarette may include a susceptor which may be heated by the induction heater.

For example, the heater 13 may include a tube-type heating element, a plate-type heating element, a needle-type heating element, or a rod-type heating element, and may heat the inside or the outside of the cigarette 2, according to the shape of the heating element.

Also, the aerosol generating device 1 may include a plurality of heaters 13. Here, the plurality of heaters 13 may be inserted into the cigarette 2 or may be arranged outside the cigarette 2. Also, some of the plurality of heaters 13 may be inserted into the cigarette 2 and the others may be arranged outside the cigarette 2. In addition, the shape of the heater 13 is not limited to the shapes illustrated in FIGS. 1 through 3 and may include various shapes.

The vaporizer 14 may generate aerosol by heating a liquid composition and the generated aerosol may pass through the cigarette 2 to be delivered to a user. In other words, the aerosol generated via the vaporizer 14 may move along an air flow passage of the aerosol generating device 1 and the air flow passage may be configured such that the aerosol generated via the vaporizer 14 passes through the cigarette to be delivered to the user.

For example, the vaporizer 14 may include a liquid storage, a liquid delivery element, and a heating element, but it is not limited thereto. For example, the liquid storage, the liquid delivery element, and the heating element may be included in the aerosol generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol generating device 1 may further include general-purpose components in addition to the battery 11, the controller 12, the heater 13, and the vaporizer 14. For example, the aerosol generating device 1 may include a display capable of outputting visual information and/or a motor for outputting haptic information. Also, the aerosol generating device 1 may include at least one sensor (a puff detecting sensor, a temperature detecting sensor, a cigarette insertion detecting sensor, etc.). Also, the aerosol generating device 1 may be formed as a structure that, even when the cigarette 2 is inserted into the aerosol generating device 1, may introduce external air or discharge internal air.

Although not illustrated in FIGS. 1 through 3, the aerosol generating device 1 and an additional cradle may form together a system. For example, the cradle may be used to charge the battery 11 of the aerosol generating device 1. Alternatively, the heater 13 may be heated when the cradle and the aerosol generating device 1 are coupled to each other.

The cigarette 2 may be similar to a general combustive cigarette. For example, the cigarette 2 may be divided into a first portion including an aerosol generating material and a second portion including a filter, etc. Alternatively, the second portion of the cigarette 2 may also include an aerosol generating material. For example, an aerosol generating material made in the form of granules or capsules may be inserted into the second portion.

The entire first portion may be inserted into the aerosol generating device 1, and the second portion may be exposed to the outside. Alternatively, only a portion of the first portion may be inserted into the aerosol generating device 1, or the entire first portion and a portion of the second portion may be inserted into the aerosol generating device 1. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol generating device 1. For example, opening and closing of the air passage and/or a size of the air passage formed in the aerosol generating device 1 may be adjusted by the user. Accordingly, the amount and the quality of smoking may be adjusted by the user. As another example, the external air may flow into the cigarette 2 through at least one hole formed in a surface of the cigarette 2.

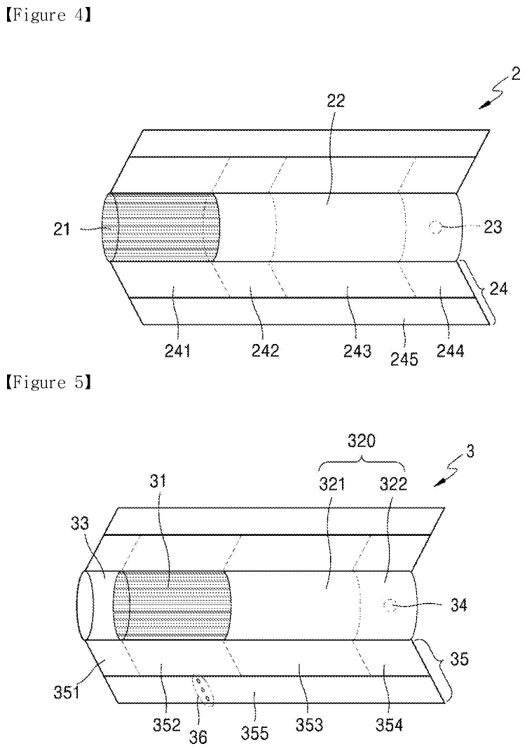

Hereinafter, an example of the cigarette 2 will be described with reference to FIGS. 4 and 5.

FIGS. 4 and 5 illustrate examples of the cigarette.

Referring to FIG. 4, the cigarette 2 may include a tobacco rod 21 and a filter rod 22. FIG. 4 illustrates that the filter rod 22 includes a single segment. However, the filter rod 22 is not limited thereto. In other words, the filter rod 22 may include a plurality of segments. For example, the filter rod 22 may include a segment configured to cool an aerosol and a segment configured to filter a certain component included in the aerosol. Also, as necessary, the filter rod 22 may further include at least one segment configured to perform other functions.

A diameter of the cigarette 2 may be in a range of 5 mm to 9 mm, and a length may be about 48 mm, but embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of the third segment of the filter rod 22 may be about 12 mm, but embodiments are not limited thereto.

The cigarette 2 may be packaged using at least one wrapper 24. The wrapper 24 may have at least one hole through which external air may be introduced or internal air may be discharged. For example, the cigarette 2 may be packaged by one wrapper 24. As another example, the cigarette 2 may be doubly packaged by two or more wrappers 24. For example, the tobacco rod 21 may be packaged by a first wrapper 241, and the filter rod 22 may be packaged by wrappers 242, 243, 243. And the entire cigarette 2 may be packaged by a single wrapper. When each of the tobacco rod 21 or the filter rod 22 is composed of a plurality of segments, each segment may be packaged by separate wrappers.

The first wrapper 241 and the second wrapper 242 may be made of general filter wrapping paper. For example, the first wrapper 241 and the second wrapper 242 may be porous wrapping paper or non-porous wrapping paper. In addition, the first wrapper 241 and the second wrapper 242 may be made of oil-resistant paper and/or an aluminum laminated-paper packaging material.

The third wrapper 243 may be made of hard wrapping paper. For example, a basis weight of the third wrapper 243 may be in a range of 88 g/m2 to 96 g/m2, preferably in a range of 90 g/m2 to 94 g/m2. In addition, a thickness of the third wrapper 243 may be in a range of 120 um to 130 um, preferably 125 um.

The fourth wrapper 244 may be made of oil-resistant hard wrapping paper. For example, a basis weight of the fourth wrapper 244 may be in a range of 88 g/m2 to 96 g/m2, preferably in a range of 90 g/m2 to 94 g/m2. In addition, a thickness of the fourth wrapper 244 may be in a range of 120 um to 130 um, preferably 125 um.

The fifth wrapper 245 may be made of sterile paper (MFW). Here, the sterile paper (MFW) may indicate paper specially made to increase tensile strength, a degree of water resistance, a degree of smoothness, and so on compared to general paper. For example, a basis weight of the fifth wrapper 245 may be in a range of 57 g/m2 to 63 g/m2, preferably 60 g/m2. In addition, a thickness of the fifth wrapper 245 may be in a range of 64 um to 70 um, preferably 67 um.

A preset material may be internally added to the fifth wrapper 245. Here, an example of the preset material may include silicon but is not limited thereto. For example, silicon has properties, such as heat resistance with little change with temperature, oxidation resistance that does not oxidize, resistance to various chemicals, water repellency, or electrical insulation. However, any material having the properties described above other than silicon may be applied (or coated) to the fifth wrapper 245 without limitation.

The fifth wrapper 245 may prevent the cigarette 2 from burning. For example, when the tobacco rod 210 is heated by the heater 13, there is a possibility that the cigarette 2 burns. In particular, when the temperature increases above an ignition point of any one of materials included in the tobacco rod 310, the cigarette 2 may burn. Even in this case, the cigarette 2 may be prevented from burning because the fifth wrapper 245 includes an incombustible material.

In addition, the fifth wrapper 245 may prevent the aerosol generating device 1 from being contaminated by materials generated from the cigarette 2. Liquid substances may be generated in the cigarette 2 by a user's puff. For example, the liquid substances (for example, moisture and so on) may be generated as the aerosol generated in the cigarette 2 is cooled due to external air. As the fifth wrapper 245 wraps the cigarette 2, liquid substances generated in the cigarette 2 may be prevented from leaking out of the cigarette 2.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat conductive material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulose acetate filter. For example, the first segment may be a tube-shaped structure including a hollow therein. When the heater 13 is inserted into the first segment, an internal material of the tobacco rod 21 may be prevented from being pushed back, and there may be a cooling effect of the aerosol. A diameter of a hollow included in the first segment may be appropriately employed within a range of 2 mm to 4.5 mm, but is not limited thereto.

A length of the first segment may be appropriately employed within a range of 4 mm to 30 mmm, but is not limited thereto. The length of the first segment may be preferably 10 mm, but is not limited thereto.

Hardness of the first segment may be adjusted by adjusting the content of a plasticizer during making of the first segment. In addition, the first segment may be made by inserting a structure, such as a film or a tube, made of the same or different material into the inside (for example, a hollow) thereof.

The second segment of the filter rod 22 may cool the aerosol generated by heating the tobacco rod 21 by using the heater 13. Accordingly, a user may inhale the aerosol cooled to an appropriate temperature.

A length or a diameter of the second segment may be variously determined according to a shape of the cigarette 2. For example, the length of the second segment may be appropriately employed within a range of 7 mm to 20 mm. The length of the second segment may be preferably about 14 mm, but is not limited thereto.

The second segment may be made by weaving polymer fibers. In this case, flavoring liquid may be applied to fibers made of polymer. Alternatively, the second segment may be made by weaving a separate fiber coated with flavoring liquid and a fiber made of a polymer together. Alternatively, the second segment may be made by a crimped polymer sheet.

For example, the polymer may be made of a material selected from a group composed of polyethylene (PE), polypropylene (PP), polyvinyl chloride (PVC), polyethylene terephthalate (PET), polylactic acid (PLA), cellulose acetate (CA), and aluminum foil.

As the second segment is made by a woven polymer fiber or a crimped polymer sheet, the second segment may include one or more longitudinally extending channels. Here, the channels may indicate passages through which gases (for example, air or aerosol) pass.

For example, a second segment composed of the crimped polymer sheet may be made of a material having a thickness between about 5 μm and about 300 μm, for example, a thickness between about 10 μm and about 250 μm. In addition, the total surface area of the second segment may be between about 300 mm2/mm and about 1000 mm2/mm. In addition, an aerosol cooling element may be made of a material having a specific surface area between about 10 mm2/mg to about 100 mm2/mg.

In addition, the second segment may include a thread including a volatile flavor component. Here, the volatile flavor component may be menthol, but is not limited thereto. For example, the thread may include sufficient menthol to provide at least 1.5 mg of menthol to the second segment.

The third segment of filter rod 22 may be a cellulose acetate filter. A length of the third segment may be appropriately employed within a range of 4 mm to 20 mm. For example, the length of the third segment may be about 12 mm, but is not limited thereto.

In the process of making the third segment, flavor may be generated by spraying flavoring liquid on the third segment. Alternatively, a separate fiber coated with flavoring liquid may be inserted into the third segment. The aerosol generated in the tobacco rod 21 may be cooled as the aerosol passes through the second segment of the filter rod 22, and the cooled aerosol may be delivered to a user through the third segment. Accordingly, when a flavor element is added to the third segment, there may be an effect of enhancing the persistence of the flavor delivered to a user.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 5, the cigarette 3 according to an embodiment may further include a front-end plug 33. The front-end plug 33 may be located on one side of the tobacco rod 31 which is opposite to the filter rod 32. The front-end plug 33 may prevent the tobacco rod 31 from being detached outwards and prevent the liquefied aerosol from flowing from the tobacco rod 31 into the aerosol generating device (1 of FIGS. 1 through 3), during smoking.

The filter rod 32 may include a first segment 321 and second segment 322. Here, the first segment 321 can correspond to a first segment of a filter rod 22 of FIG. 4, and the second segment 322 can correspond to a third segment of a filter rod 22 of FIG. 4.

The diameter and total length of the cigarette 3 can correspond to the diameter and total length of the cigarette 2 of FIG. 4. For example, the length of the front-end plug 33 may be about 7 mm, the length of the tobacco rod 31 may be about 15 mm, the length of the first segment 321 may be about 12 mm, and the length of the second segment 322 may be about 14 mm, but it is not limited to this.

The cigarette 3 may be packaged via at least one wrapper 35. The wrapper 35 may have at least one hole through which external air may be introduced or internal air may be discharged. For example, the front-end plug 33 may be packaged via a first wrapper 351, and the tobacco rod 31 may be packaged via a second wrapper 352, and the first segment 321 may be packaged via a third wrapper 353, and the second segment 322 may be packaged via a fourth wrapper 354. Also, the entire cigarette 3 may be packaged via a fifth wrapper 355.

Also, the fifth wrapper 355 may have at least one hole 36. For example, the hole 36 may be formed in an area surrounding the tobacco rod 31, but is not limited thereto. The hole 36 may serve to transfer heat formed by the heater 13 shown in FIG. 2 and FIG. 3 to the inside of the tobacco rod 31.

Also, the second segment 322 may include at least one capsule 34. Here, the capsule 34 may generate a flavor or an aerosol. For example, the capsule 34 may have a configuration in which a liquid containing a flavoring material is wrapped with a film. For example, the capsule 34 may have a spherical or cylindrical shape, but is not limited thereto.

The first wrapper 351 may be made by coupling a metal foil, such as an aluminum foil, coupled to a general filter wrapping paper. For example, the total thickness of the first wrapper 351 may be in a range of 45 um to 55 um and may be preferably 50.3 um. In addition, a thickness of the metal foil of the first wrapper 351 may be in a range of 6 um to 7 um, preferably 6.3 um. In addition, a basis weight of the first wrapper 351 may be in a range of 50 g/m2 to 55 g/m2 and may be preferably 53 g/m2.

The second wrapper 352 and the third wrapper 353 may be made of general filter wrapping paper. For example, the second wrapper 352 and the third wrapper 353 may be porous wrapping paper or non-porous wrapping paper.

For example, porosity of the second wrapper 352 may be 35000 CU, but is not limited thereto. In addition, a thickness of the second wrapper 352 may be in a range of 70 um to 80 um, preferably 78 um. In addition, the basis weight of the second wrapper 352 may be in a range of 20 g/m2 to 25 g/m2 and may be preferably 23.5 g/m2.

For example, porosity of the third wrapper 353 may be 24000 CU, but is not limited thereto. In addition, a thickness of the third wrapper 353 may be in a range of 60 um to 70 um, preferably 68 um. In addition, a basis weight of the third wrapper 353 may be in a range of 20 g/m2 to 25 g/m2 and may be preferably 21 g/m2.

The fourth wrapper 354 may be made of PLA laminated paper. Here, the PLA laminated paper means three layers of paper including a paper layer, a PLA layer, and another paper layer. For example, a thickness of the fourth wrapper 354 may be in a range of 100 um to 120 um, preferably 110 um. In addition, a basis weight of the fourth wrapper 354 may be in a range of 80 g/m2 to 100 g/m2 and may be preferably 88 g/m2.

The fifth wrapper 355 may be made of sterile paper (MFW). Here, the sterile paper (MFW) may indicate paper specially made to increase tensile strength, a degree of water resistance, a degree of smoothness, and so on compared to general paper. For example, a basis weight of the fifth wrapper 355 may be in a range of 57 g/m2 to 63 g/m2 and may be preferably 60 g/m2. In addition, a thickness of the fifth wrapper 355 may be in a range of 64 um to 70 um, preferably 67 um.

A preset material may be internally added to the fifth wrapper 355. Here, for example, the preset material may be silicon, but is not limited thereto. For example, silicon has properties, such as heat resistance with little change with temperature, oxidation resistance that does not oxidize, resistance to various chemicals, water repellency, or electrical insulation. However, any material having the properties described above other than silicon may be applied (or coated) to the fifth wrapper 245 without limitation.

A front-end plug 33 may be made of cellulose acetate. For example, the front-end plug 33 may be made by adding a plasticizer (for example, triacetin) to cellulose acetate tow. A mono denier of a filament constituting the cellulose acetate tow may be in a range of 1.0 to 10.0, preferably in a range of 4.0 to 6.0. More preferably, a mono denier of a filament of the front-end plug 33 may be 5.0. In addition, a cross section of the filament constituting the front-end plug 33 may be Y-shaped. The total denier of the front-end plug 33 may be in a range of 20000 to 30000, preferably in a range of 25000 to 30000. More preferably, the total denier of the front-end plug 33 may be 28000.

In addition, as necessary, the front-end plug 33 may include at least one channel, and a cross-sectional shape of the channel may be various.

A tobacco rod 31 may correspond to the tobacco rod 21 described above with reference to FIG. 4. Accordingly, detailed descriptions of the tobacco rod 31 are omitted below.

The first segment 321 may be made of cellulose acetate. For example, the first segment 321 may have a tube-shaped structure including a hollow therein. The first segment 321 may be made by adding a plasticizer (for example, triacetin) to cellulose acetate tow. For example, a mono denier and the total denier of the first segment 321 may be the same as the mono denier and the total denier of the front-end plug 33.

The second segment 322 may be made of cellulose acetate. A mono denier of a filament constituting the second segment 322 may be in a range of 1.0 to 10.0, preferably in a range of 8.0 to 10.0. More preferably, the mono denier of the filament of the second segment 322 may be 9.0. In addition, a cross section of the filament of the second segment 322 may be Y-shaped. The total denier of the second segment 322 may be in a range of 20000 to 30000, preferably 25000.

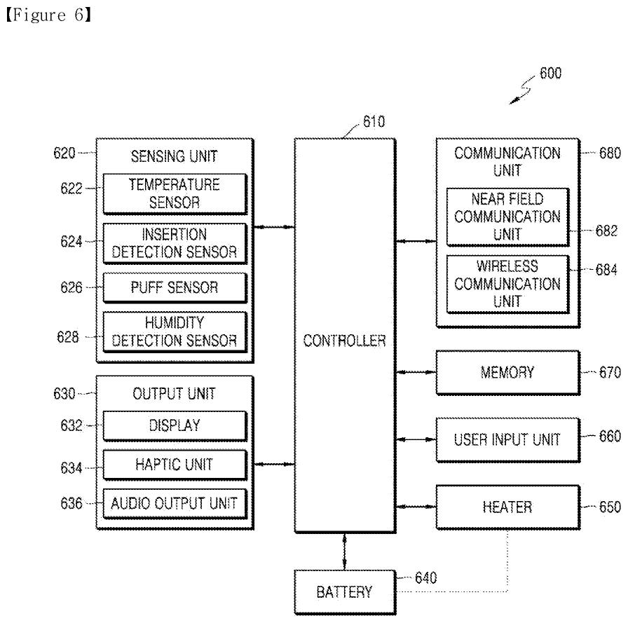

FIG. 6 is a block diagram of an aerosol generating device 600 according to another embodiment.

The aerosol generating device 600 may include a controller 610, a sensing unit 620, an output unit 630, a battery 640, a heater 650, a user input unit 660, a memory 670, and a communication unit 680. However, the internal structure of the aerosol generating device 600 is not limited to those illustrated in FIG. 6. That is, according to the design of the aerosol generating device 600, it will be understood by one of ordinary skill in the art that some of the components shown in FIG. 6 may be omitted or new components may be added.

The sensing unit 620 may sense a state of the aerosol generating device 600 and a state around the aerosol generating device 600, and transmit sensed information to the controller 610. Based on the sensed information, the controller 610 may control the aerosol generating device 600 to perform various functions, such as controlling an operation of the heater 650, limiting smoking, determining whether an aerosol generating article (e.g., a cigarette, a cartridge, or the like) is inserted, displaying a notification, or the like.

The sensing unit 620 may include at least one of a temperature sensor 622, an insertion detection sensor 624, a puff sensor 626, and a humidity detection sensor 628, but is not limited thereto.

The temperature sensor 622 may sense a temperature at which the heater 650 (or an aerosol generating material) is heated. The aerosol generating device 600 may include a separate temperature sensor for sensing the temperature of the heater 650, or the heater 650 may serve as a temperature sensor. Alternatively, the temperature sensor 622 may also be arranged around the battery 640 to monitor the temperature of the battery 640.

The temperature sensor 622 may measure the temperature at which the heater 650 (or an aerosol generating material) is heated and provide the measured temperature to the controller 610. The controller 610 may calculate the time (“temperature increase time”) required for the measured temperature to reach volatilization temperature of the aerosol generating material by using the temperature sensor 622 and compare the calculated temperature increase time with a preset threshold to determine a humidity state of the cigarette 2 of FIG. 2. The controller 610 may control power supplied to the heater 650 based on the determined humidity state of the cigarette.

The insertion detection sensor 624 may sense insertion and/or removal of an aerosol generating article. For example, the insertion detection sensor 624 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 626 may sense a user's puff on the basis of various physical changes in an airflow passage or an airflow channel. For example, the puff sensor 626 may sense a user's puff on the basis of any one of a temperature change, a flow change, a voltage change, and a pressure change.

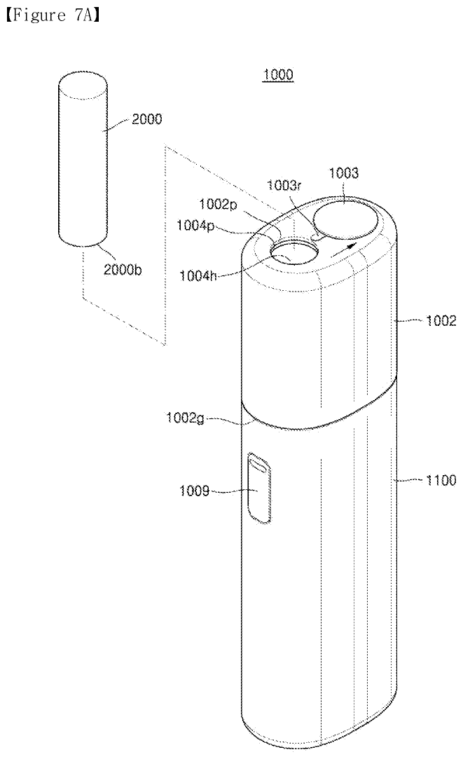

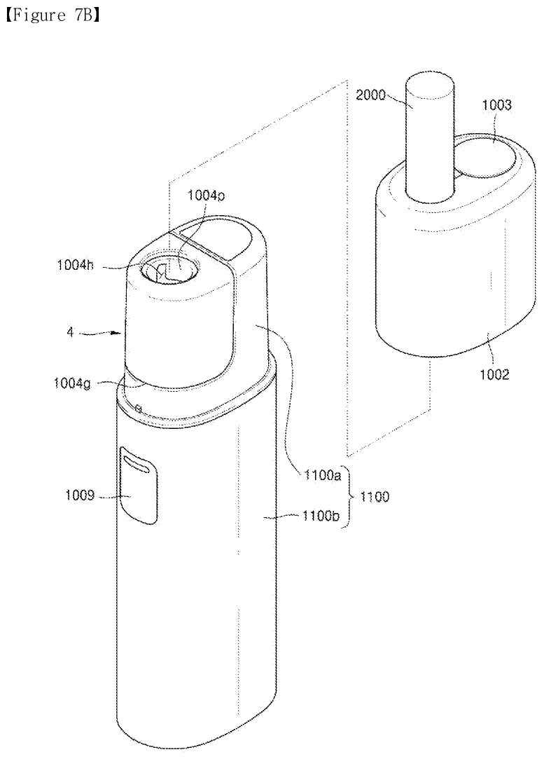

According to an embodiment, the humidity detection sensor 628 may directly measure the amount of moisture included in the cigarette 2 of FIG. 2 and provide the measured humidity information to the controller 610. For example, the humidity detection sensor 628 may be within an accommodation passage 1004h (in FIG. 7A) of the aerosol generating device 600. According to another embodiment, the humidity detection sensor 628 may measure the amount of moisture condensed around the cigarette 2 after the cigarette 2 of FIG. 2 is heated. When heated, moisture evaporation of the excessively moist cigarette may be greater than moisture evaporation of a normal cigarette. Due to this, when heated, dew condensation may occur more in the excessively moist cigarette than in the normal cigarette. For example, the humidity detection sensor 628 may be around an outer hole 1002p of FIG. 7A overlapping the accommodation passage 1004h (in FIG. 7A) of the aerosol generating device 600 or at a door 1003 of FIG. 7A.

The humidity detection sensor 628 may be any one of an electrical resistance sensor, a capacitance sensor, and an optical sensor. However, this is an example, and the humidity detection sensor 628 is not limited thereto.

The sensing unit 620 may include, in addition to the temperature sensor 622, the insertion detection sensor 624, and the puff sensor 626 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 630 may output information on a state of the aerosol generating device 600 and provide the information to a user. The output unit 630 may include at least one of a display unit 632, a haptic unit 634, and a sound output unit 636, but is not limited thereto. When the display unit 632 and a touch pad form a layered structure to form a touch screen, the display unit 632 may also be used as an input device in addition to an output device.

The display unit 632 may visually provide information about the aerosol generating device 600 to the user. For example, information about the aerosol generating device 600 may mean various pieces of information, such as a charging/discharging state of the battery 640 of the aerosol generating device 600, a preheating state of the heater 650, an insertion/removal state of an aerosol generating article, or a state in which the use of the aerosol generating device 600 is restricted (e.g., sensing of an abnormal object), or the like, and the display unit 632 may output the information to the outside. The display unit 632 may be, for example, a liquid crystal display panel (LCD), an organic light-emitting diode (OLED) display panel, or the like. In addition, the display unit 632 may be in the form of a light-emitting diode (LED) light-emitting device.

The haptic unit 634 may tactilely provide information about the aerosol generating device 600 to the user by converting an electrical signal into a mechanical stimulus or an electrical stimulus. For example, the haptic unit 634 may include a motor, a piezoelectric element, or an electrical stimulation device.

The sound output unit 636 may audibly provide information about the aerosol generating device 600 to the user. For example, the sound output unit 636 may convert an electrical signal into a sound signal and output the same to the outside.

The battery 640 may supply power used to operate the aerosol generating device 600. The battery 640 may supply power such that the heater 650 may be heated. In addition, the battery 640 may supply power required for operations of other components (e.g., the sensing unit 620, the output unit 630, the user input unit 660, the memory 670, and the communication unit 680) in the aerosol generating device 600. The battery 640 may be a rechargeable battery or a disposable battery. For example, the battery 640 may be a lithium polymer (LiPoly) battery, but is not limited thereto.

The heater 650 may receive power from the battery 640 to heat an aerosol generating material. Although not illustrated in FIG. 6, the aerosol generating device 600 may further include a power conversion circuit (e.g., a direct current (DC)/DC converter) that converts power of the battery 640 and supplies the same to the heater 650. In addition, when the aerosol generating device 600 generates aerosols in an induction heating method, the aerosol generating device 600 may further include a DC/alternating current (AC) that converts DC power of the battery 640 into AC power.

The controller 610, the sensing unit 620, the output unit 630, the user input unit 660, the memory 670, and the communication unit 680 may each receive power from the battery 640 to perform a function. Although not illustrated in FIG. 6, the aerosol generating device 600 may further include a power conversion circuit that converts power of the battery 640 to supply the power to respective components, for example, a low dropout (LD0) circuit, or a voltage regulator circuit.

In an embodiment, the heater 650 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 650 may be implemented by a metal wire, a metal plate on which an electrically conductive track is arranged, a ceramic heating element, or the like, but is not limited thereto.

In another embodiment, the heater 650 may be a heater of an induction heating type. For example, the heater 650 may include a suspector that heats an aerosol generating material by generating heat through a magnetic field applied by a coil.

In an embodiment, the heater 650 may include a plurality of heaters. For example, the heater 650 may include a first heater for heating the cigarette and a second heater for heating the liquid composition.

The user input unit 660 may receive information input from the user or may output information to the user. For example, the user input unit 660 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 6, the aerosol generating device 600 may further include a connection interface, such as a universal serial bus (USB) interface, and may connect to other external devices through the connection interface, such as the USB interface, to transmit and receive information, or to charge the battery 640.

The memory 670 is a hardware component that stores various types of data (i.e. temperature profile) processed in the aerosol generating device 600, and may store data processed and data to be processed by the controller 610. The memory 670 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 670 may store an operation time of the aerosol generating device 600, the maximum number of puffs, the current number of puffs, at least one temperature profile, data on a user's smoking pattern, etc.

The communication unit 680 may include at least one component for communication with another electronic device. For example, the communication unit 680 may include a short-range wireless communication unit 682 and a wireless communication unit 684.

The short-range wireless communication unit 682 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 684 may include a cellular network communication unit, an Internet communication unit, a computer network (e.g., local area network (LAN) or wide area network (WAN)) communication unit, or the like, but is not limited thereto. The wireless communication unit 684 may also identify and authenticate the aerosol generating device 600 within a communication network by using subscriber information (e.g., International Mobile Subscriber Identifier (IMSI)).

The controller 610 may control general operations of the aerosol generating device 600. In an embodiment, the controller 610 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 610 may control the temperature of the heater 650 by controlling supply of power of the battery 640 to the heater 650. For example, the controller 610 may control power supply by controlling switching of a switching element between the battery 640 and the heater 650. In another example, a direct heating circuit may also control power supply to the heater 650 according to a control command of the controller 610.

The controller 610 may analyze a result sensed by the sensing unit 620 and control subsequent processes to be performed. For example, the controller 610 may control power supplied to the heater 650 to start or end an operation of the heater 650 on the basis of a result sensed by the sensing unit 620. As another example, the controller 610 may control, based on a result sensed by the sensing unit 620, an amount of power supplied to the heater 650 and the time the power is supplied, such that the heater 650 may be heated to a certain temperature or maintained at an appropriate temperature.

The controller 610 may control the output unit 630 on the basis of a result sensed by the sensing unit 620. For example, when the number of puffs counted through the puff sensor 626 reaches a preset number, the controller 610 may notify the user that the aerosol generating device 600 will soon be terminated through at least one of the display unit 632, the haptic unit 634, and the sound output unit 636.

The controller 610 may determine the humidity state of the cigarette by using the temperature sensor 622. The controller 610 may operate the heater 950 with a temperature profile corresponding to the determined humidity state of the cigarette.

Hereinafter, a normal cigarette and an excessively moist cigarette are classified on the basis of the temperature increase time of the cigarette 2 of FIG. 2, and when a cigarette corresponds to the excessively moist cigarette, an aerosol generating device to which a compensation profile is applied and an operating method thereof are described in detail with reference to FIGS. 7A to 11.

FIG. 7A is a perspective view illustrating an appearance of an aerosol generating device according to an embodiment of the present disclosure. FIG. 7B is a perspective view illustrating an operating state in which some components are separated from the aerosol generating device according to the embodiment illustrated in FIG. 7A.

Referring to FIG. 7A, an aerosol generating device 1000 may include a case 1100 and a cover 1002. The cover 1002 is coupled to one end portion of the case 1100, and accordingly, the case 1100 and the cover 1002 form together an appearance of the aerosol generating device 1000.

The case 1100 forms a part of the appearance of the aerosol generating device 1000 and functions to accommodate and protect various components therein.

The cover 1002 and the case 1100 may be made of a plastic material that does not transfer heat well or a metal material coated with a thermal barrier material on a surface thereof. The cover 1002 and the case 1100 may be made by, for example, an injection molding method, a three dimensional (3D) printing method, or a method of assembling small components made by injection molding.

A holding device (not illustrated) may be installed between the cover 1002 and the case 1100 to maintain a coupled state of the cover 1002 and the case 1100. The holding device may include, for example, a protrusion and a groove. By maintaining a state in which the protrusion is inserted into the groove, the coupled state of the cover 1002 and the case 1100 may be maintained, and a structure in which the protrusion is moved to be separated from the groove by an operation button that may be pressed by a user may also be used.

In addition, the holding device may include, for example, a magnet and a metal member sticking to the magnet. When a magnet is used for the holding device, a magnet may be installed in one of the case 1100 and the cover 1002, and a metal member that is attached to the magnet may be installed in the other, or the magnet may also be installed in both the case 1100 and the cover 1002.

An outer hole 1002p into which the cigarette 2000 may be inserted is formed in an upper surface of the cover 1002 coupled to the case 1100. In addition, a rail 1003r is formed on the upper surface of the cover 1002 at a position adjacent to the outer hole 1002p. A door 1003 that may slide along the upper surface of the cover 1002 is installed on the rail 1003r. The door 1003 may linearly slide along the rail 1003r.

As the door 1003 moves along the rail 1003r in a direction of an arrow in FIG. 7A, the outer hole 1002p and an insertion hole 1004p, which allow the cigarette 2000 to pass through the cover 1002 and be inserted into the case 1100 may be exposed to the outside. The outer hole 1002p of the cover 1002 serves to expose, to the outside, the insertion hole 1004p of the accommodation passage 1004h that may accommodate the cigarette 2000.

When the outer hole 1002p is exposed to the outside by the door 1003, a user may insert an end portion 2000b of the cigarette 2000 into the outer hole 1002p and the insertion hole 1004p to mount the cigarette 2000 in the accommodation passage 1004h formed inside the cover 1002.

The rail 1003r has a concave groove shape, but the embodiment is not limited by the shape of the rail 1003r. For example, the rail 1003r may have a convex shape or may also extend in a curved shape instead of a straight line.

A button 1009 may be installed in the case 1100. An operation of the aerosol generating device 1000 may be controlled by operating the button 1009.

In a state where the cover 1002 is coupled to the case 1100, an air inflow gap 1002g, which allows air to flow into the cover 1002, is formed at a portion where the cover 1002 is coupled to the case 1100.

Referring to FIG. 7B, while the cigarette 2000 is inserted into the aerosol generating device 1000, a user may place the cigarette 2000 in his/her mouth and inhale an aerosol.

The case 1100 may include an upper case 1100a into which the cigarette 2000 is inserted and is heated, and a lower case 1100b that supports and protects various components installed therein. Hereinafter, the case 1100 may collectively refer to the upper case 1100a and the lower case 1100b.

The cover 1002 may be coupled to the case 1100 to cover a cigarette support portion 4 coupled to the case 1100. In addition, the cover 1002 may be separated from the case 1100 as needed.

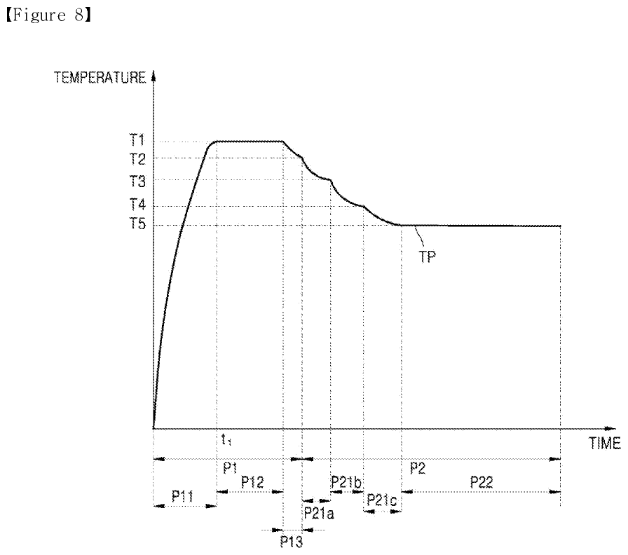

FIG. 8 is an example diagram illustrating a basic temperature profile of an aerosol generating device.

Referring to FIGS. 6 and 8, the controller 610 of the aerosol generating device 600 may calculate a temperature increase time t1 of the cigarette 2000 of FIG. 7A by using the temperature sensor 622 and may compare the calculated temperature increase time t1 of the cigarette 2000 with a preset threshold to determine a humidity state of the cigarette 2000. When the temperature increase time t1 is less than the threshold, the controller 610 may supply power to the heater 650 according to a basic temperature profile TP.

In this case, the preset threshold is the time it takes for an excessively moist cigarette to reach a first target temperature T1 and may be determined experimentally and statistically. In a case where the temperature increase time to reach the first target temperature T1 is greater than or equal to the threshold, if the heater 650 operates according to the basic temperature profile TP, a user may feel hot due to moisture included in the cigarette 2000.

As illustrated in FIG. 8, the basic temperature profile TP may include a first preheating period P1 and a first smoking period P2, and the first preheating period P1 and the first smoking period P2 may be divided into more subdivided periods.

The first preheating period P1 may include a first preheating increase period P11 (or the temperature increase time t1) in which the temperature increases to the first target temperature T1, a first preheating maintenance period P12 in which the first target temperature T1 is maintained, and a first preheating drop period P13 in which the temperature drops to a second target temperature T2. The first smoking period P2 may include a first smoking drop period P21a in which the temperature drops to a third target temperature T3, a second smoking drop period P21b in which the temperature drops to a fourth target temperature T4, a third smoking drop period P21c in which the temperature drops to a fifth target temperature T5, and a first smoking maintenance period P22 in which the fifth target temperature T5 is maintained. Here, although an example, in which the first preheating period P1 includes the first preheating increase period P11, the first preheating maintenance period P12, and the first preheating drop period P13, and the first smoking period P2 includes the first smoking drop period P21a, the second smoking drop period P21b, the third smoking drop period P21c, and the first smoking maintenance period P22, is described, the example is not limited thereto, and various modifications may be made depending on shapes or types of a cigarette or a heater.

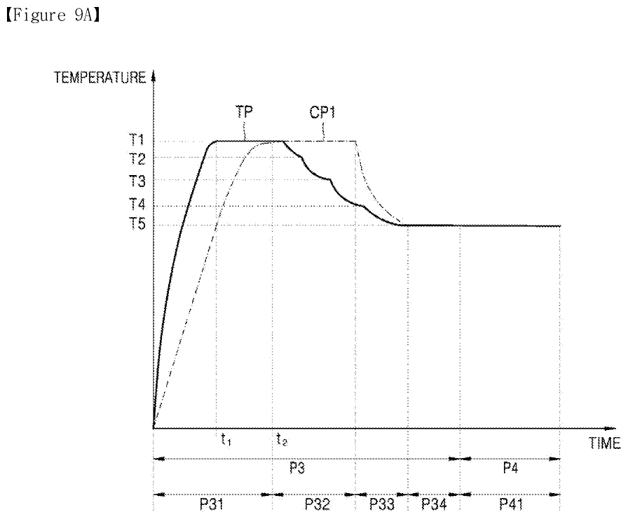

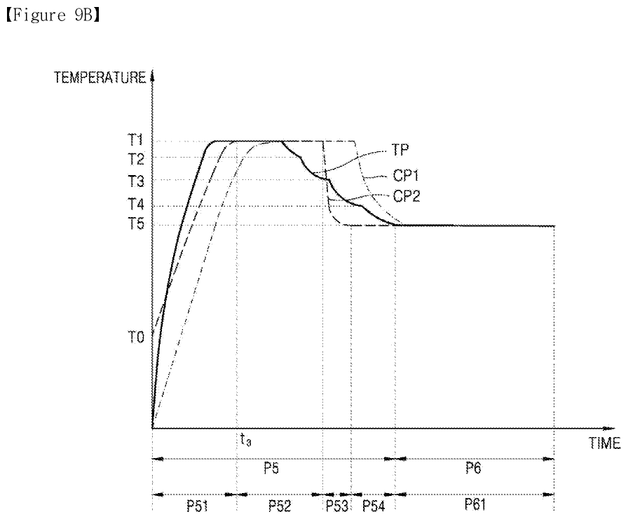

FIG. 9A is an example diagram illustrating a first correction profile of an aerosol generating device.

Referring to FIGS. 6, 8, and 9A, when it is determined that the inserted cigarette 2000 of FIG. 7A is an excessively moist cigarette, the aerosol generating device 600 may operate the heater 650 by applying a first correction profile CP1 that is described below.

The controller 610 according to an embodiment may calculate the temperature increase time t2 of the cigarette 2000 by using the temperature sensor 622 and compare the calculated temperature increase time t2 of the cigarette 2000 with a preset threshold (e.g., t1) to determine a humidity state of the cigarette 2000. When the temperature increase time t2 is greater than or equal to the threshold, the controller 610 may supply power to the heater 650 according to the first correction profile CP1.

However, a method of determining a humidity state of the cigarette 2000 is not limited thereto. The controller 610 according to another embodiment may determine the humidity state of the cigarette 2000 by using the humidity detection sensor 628.

According to an embodiment, the humidity detection sensor 628 may directly measure the amount of moisture included in the cigarette 2000 and provide the measured humidity information to the controller 610. For example, the humidity detection sensor 628 may be in the accommodation passage 1004h (in FIG. 7A) of the aerosol generating device 600. According to another embodiment, the humidity detection sensor 628 may measure the amount of moisture condensed around the cigarette after the cigarette 2 of FIG. 2 is heated. When heated, moisture evaporation of the excessively moist cigarette may be greater than moisture evaporation of a normal cigarette. Due to this, when heated, dew condensation may occur more in the excessively moist cigarette than in the normal cigarette. For example, the humidity detection sensor 628 may be around the outer hole 1002p of FIG. 7A overlapping the accommodation passage 1004h (in FIG. 7A) of the aerosol generating device 600 or may be in the door 1003 of FIG. 7A.

The humidity detection sensor 628 may be any one of an electrical resistance sensor, a capacitance sensor, and an optical sensor. However, this is an example, and the humidity detection sensor 628 is not limited thereto.

As illustrated in FIG. 9A, the first correction profile CP1 may include a second preheating period P3 and a second smoking period P4, and the second preheating period P3 and the second smoking period P4 may be divided into more subdivided periods.

The second preheating period P3 may include a second preheating increase period P31 in which the temperature increases to a first target temperature T1 (or a temperature increase time t2), a second preheating maintenance period P32 in which the first target temperature T1 is maintained, a second preheating drop period P33 in which the temperature drops to a fifth target temperature T5, and a third preheating maintenance period P34 in which the fifth target temperature T5 is maintained. The second smoking period P4 may include a second smoking maintenance period P41 in which the fifth target temperature T5 is maintained. Here, although an example, in which the second preheating period P2 includes the second preheating increase period P31, the second preheating maintenance period P32, the second preheating drop period P33, and the third preheating maintenance period P34 and the second smoking period P4 includes the second smoking maintenance period P41, is described, the example is not limited thereto, and various modifications may be made depending on shapes or types of a cigarette or a heater.

Referring to FIGS. 8 and 9A, the second preheating period P3 of the first correction profile CP1 may be longer than the first preheating period P1 of the basic temperature profile TP.

Specifically, the second preheating period P31 of the first correction profile CP1 may be longer than the first preheating period P11 of the basic temperature profile TP. For example, there may be a difference of about 3 to 4 seconds between a point in time t2 when the first target temperature T1 of the first correction profile CP1 reaches and a point in time t1 when the first target temperature T1 of the basic temperature profile TP reaches. This is because an excessively moist cigarette has more moisture than a normal cigarette, and accordingly, not only is the evaporation of moisture to be heated delayed, but also a rate of temperature increase of a cigarette may be slowed down.

The second preheating maintenance period P32 of the first correction profile CP1 may be longer than the first preheating maintenance period P12 of the basic temperature profile TP. As such, more moisture included in the cigarette 2000 may be evaporated, and accordingly initial hot feeling may be reduced.

In addition, a temperature change in the second preheating drop period P33 of the first correction profile CP1 may be greater than a temperature change in the first preheating drop period P13 of the basic temperature profile TP. For example, the first preheating drop period P13 may change from the first target temperature T1 to the second target temperature T2, but the second preheating drop period P33 may change from the first target temperature T1 to the fifth target temperature T5. Because a user is unlikely to feel hot due to moisture included in a normal cigarette, smoking may start at the second target temperature T2 higher than the fifth target temperature T5. On the other hand, because moisture included in an excessively moist cigarette is more than moisture included in a normal cigarette, a temperature change in the second preheating drop period P33 may be set to be greater, and thus the initial hot feeling may be reduced.

In addition, in order to reduce the initial hot feeling, the second preheating period P3 of the first correction profile CP1 may further include the third preheating maintenance period P34 in which the fifth target temperature T5 is maintained.

FIG. 9B is an example diagram illustrating a second correction profile of an aerosol generating device.

Referring to FIGS. 6, 8, 9A, and 9B, the controller 610 of the aerosol generating device 600 may detect insertion of the cigarette 2000 of FIG. 7A by using the insertion detection sensor 624. When the insertion of the cigarette 2000 is detected, the controller 610 may check whether the first correction profile CP1 was used during heating by the heater 650 immediately before. For example, the controller 610 may check whether the first correction profile CP1 was used when the heating was made by the heater 650 immediately before, on the basis of a temperature profile use history stored in the memory 670.

When it is determined that the first correction profile CP1 was used during the heating by the heater 650 immediately before, the controller 610 may determine whether the heater 650 is being used continuously (or repeatedly).

The controller 610 according to an embodiment may determine whether the heater 650 was used continuously (or repeatedly) by using the temperature sensor 622.

When the measured temperature of the heater 650 is less than a reference temperature, the controller 610 may determine that the use is not continuous and may determine again a humidity state of the cigarette 2000. For example, the controller 610 may determine the humidity state of the cigarette 2000 by using the temperature sensor 622 or the humidity detection sensor 628. When it is determined that the cigarette 2000 is a normal cigarette according to the humidity state, the controller 610 may supply power to the heater 650 according to the basic temperature profile TP, and when it is determined that the cigarette 2000 is an excessively moist cigarette according to the humidity state, the controller 610 may supply power to the heater 650 according to the first correction profile CP1.

On the other hand, when the measured temperature of the heater 650 is higher than or equal to the reference temperature, the controller 610 determines that the use is continuous, select the second correction profile CP2, and supply power to the heater 650 according to the second correction profile CP2. Since the first correction profile CP1 was selected at the time of a previous smoking event, and it is common for cigarette 2000 to be packaged in units of a certain number (for example, 20 pieces) in the case of continuous use, the inserted cigarettes 2000 is also highly likely to be an excessively moist cigarette in this case.

According to another embodiment, the controller 610 may also determine whether the heater 650 is being used continuously (or repeatedly) by comparing an interval between an end of the previous smoking event and a start of the current smoking event with a preset time.

If the interval exceeds the preset time, the controller 610 may determine that the use is not continuous and may determine again a humidity state of the cigarette 2000 (select a basic temperature profile or a first correction profile). On the other hand, when the interval is within the preset time, the controller 610 may determine that the use is continuous (select a second correction profile).

As illustrated in FIG. 9B, the second correction profile CP2 may include a third preheating period P5 and a third smoking period P6, and the third preheating period P5 and the third smoking period P6 may be divided into more subdivided periods.

The third preheating period P5 of the second correction profile CP2 may a third preheating increase period P51 in which the temperature increases to a first target temperature T1 (or a temperature increase time t2), a fourth preheating maintenance period P52 in which the first target temperature T1 is maintained, a third preheating drop period P53 in which the temperature drops to a fifth target temperature T5, and a fifth preheating maintenance period P54 in which the fifth target temperature T5 is maintained. The third smoking period P5 may include a third smoking maintenance period P61 in which the fifth target temperature T5 is maintained. Here, although an example, in which the third preheating period P3 includes the third preheating increase period P51, the fourth preheating maintenance period P52, the third preheating drop period P53, and the fifth preheating maintenance period P54 and the third smoking period P6 includes the third smoking maintenance period P61, is described, the example is not limited thereto, and various modifications may be made depending on shapes or types of a cigarette or a heater.

The third preheating period P5 of the second correction profile CP2 may be longer than the first preheating period P1 of the basic temperature profile TP and may be shorter than the second preheating period P3 of the first correction profile CP1.

Specifically, the fourth preheating period maintenance period P52 of the second correction profile CP2 may be longer than the first preheating period P12 of the basic temperature profile TP. Due to this, more moisture included in the cigarette 2000 may be evaporated, and accordingly initial hot feeling may be reduced.

In addition, a temperature change in the third preheating drop period P53 of the second correction profile CP2 may be greater than a temperature change in the first preheating drop period P13 of the basic temperature profile TP. For example, the first preheating drop period P13 may change from the first target temperature T1 to the second target temperature T2, but the third preheating drop period P53 may change from the first target temperature T1 to the fifth target temperature T5. Because a user is unlikely to feel hot due to moisture included in a normal cigarette, smoking may start at the second target temperature T2 higher than the fifth target temperature T5. On the other hand, because moisture included in an excessively moist cigarette is more than moisture included in a normal cigarette, a temperature change in the third preheating drop period P53 may be set to be greater, and thus the initial hot feeling may be reduced.

In addition, in order to reduce the initial hot feeling, the third preheating period P5 of the second correction profile CP2 may further include a fifth preheating maintenance period P54 in which the fifth target temperature T5 is maintained.

A start temperature TO of the second correction profile CP2 may be higher than a start temperature (e.g., room temperature of about 15° C.) of the first correction profile CP1. Accordingly, the temperature increase time t3 of the second correction profile CP2 for the temperature reach the first target temperature T1 may be shorter than the temperature increase time t2 of the first correction profile CP1. In this case, because the aerosol generating device 600 initially has a high temperature, there is a problem in that a hot feeling may be given to a user.

In this regard, the second correction profile CP2 takes a longer preheating time after reaching the first target temperature T1 than the first correction profile CP1, and thus initial hot feeling may be reduced.

Referring to FIGS. 9A and 9B, the preheating time after reaching the first target temperature T1 of the second correction profile CP2 may correspond to the sum of the fourth preheating maintenance period P52, the third preheating drop period P53, and the fifth preheating maintenance period P54, and the preheating time after reaching the first target temperature T1 of the first correction profile CP1 may correspond to the sum of the second preheating maintenance period P32, the second preheating drop period P33, and the third preheating maintenance period P34. Here, the sum of the fourth preheating maintenance period P52, the third preheating drop period P53, and the fifth preheating maintenance period P54 is longer than the sum of the second preheating maintenance period P32, the second preheating drop period P33, and the third preheating maintenance period P34. In other words, the third smoking period P6 of the second correction profile CP2 may be substantially the same as the second smoking period P4 of the first correction profile CP1.

In addition, the time (that is, the fourth preheating maintenance period P52) for maintaining the first target temperature T1 of the second correction profile CP2 may also be shorter than the time (that is, the second preheating maintenance period P32) for maintaining the first target temperature T1 of the first correction profile CP1.

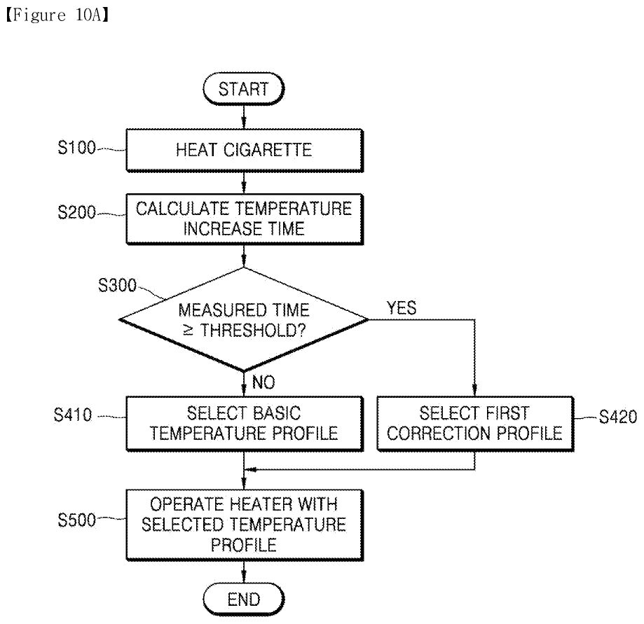

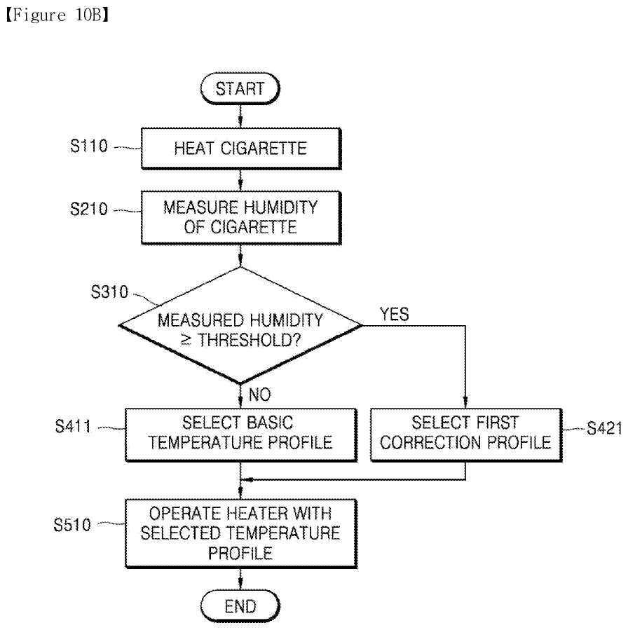

FIG. 10A is a flowchart illustrating an operating method of an aerosol generating device, according to an embodiment considering a humidity state of a cigarette.

Referring to FIGS. 6 to 10A, the operating method of the aerosol generating device may include step S100 of heating the cigarette 2000 by using the heater 650, step S200 of calculating a temperature increase time of the cigarette 2000 by measuring temperature of the heater 650 by using the temperature sensor 622, step S300 of determining a humidity state of the cigarette 2000 by comparing the calculated temperature increase time of the cigarette 2000 with a preset threshold, steps S410 and S420 of selecting a temperature profile corresponding to the determined humidity state of the cigarette 2000, and step S500 of operating the heater 650 with the selected temperature profile.

Specifically, in step S100 of heating the cigarette 2000 by using the heater 650, since an excessively moist cigarette has more moisture than a normal cigarette, evaporation of moisture to be heated is delayed, and thus a rate of temperature increase of an excessively moist cigarette may be slowed down.

In step S200 of calculating a temperature increase time of the cigarette 2000 by measuring the temperature of the heater 650 by using the temperature sensor 622, the controller 610 may determine the time it takes for the temperature of the heater 650 to reach the preset first target temperature T1 as the temperature increase time of the cigarette 2000.

In step S300 of determining the humidity state of the cigarette 2000 by comparing the calculated temperature increase time of the cigarette 2000 with the preset threshold, the controller 610 may determine the cigarette 2000 as a normal cigarette when the temperature increase time is less than the threshold and may determine the cigarette 2000 as an excessively moist cigarette when the temperature increase time is greater than or equal to the threshold.

In this case, the preset threshold is the time it takes for the excessively moist cigarette to reach the first target temperature T1, and may be determined experimentally and statistically. If the time to reach the first target temperature T1 is greater than or equal to the threshold and the heater 650 operates according to the basic temperature profile TP, a user may feel hot due to the moisture included in the cigarette 2000.

In steps S410 and S420 of selecting a temperature profile corresponding to the determined humidity state of the cigarette 2000, the controller 610 may select the basic temperature profile TP when the temperature increase time is less than the threshold, and may select the first correction profile CP1 when the temperature increase time is greater than or equal to the threshold.

In step S500 of operating the heater 650 with the selected temperature profile, the controller 610 may supply power to the heater 650 according to the basic temperature profile TP when the temperature increase time is less than the threshold, and may supply power to the heater 650 according to the first correction profile CP1 when the temperature increase time is greater than or equal to the threshold.

The basic temperature profile TP may include a first preheating period P1 and a first smoking period P2, and the first preheating period P1 and the first smoking period P2 may be divided into further subdivided periods. The first correction profile CP1 may include a second preheating period P3 and a second smoking period P4, and the second preheating period P3 and the second smoking period P4 may be divided into further subdivided periods.

The second preheating period P3 of the first correction profile CP1 may be longer than the first preheating period P1 of the basic temperature profile TP.

Specifically, a second preheating increase period P31 of the first correction profile CP1 may be longer than a first preheating increase period P11 of the basic temperature profile TP.

A second preheating maintenance period P32 may be longer than a first preheating maintenance period P12. Due to this, more moisture included in the cigarette 2000 may be evaporated, and initial hot feeling may be reduced.

In addition, a temperature change in the second preheating drop period P33 may be greater than a temperature change in a first preheating drop period P13. Because a user is unlikely to feel hot due to moisture included in a normal cigarette, smoking may start at the second target temperature T2 higher than the fifth target temperature T5. On the other hand, because moisture included in an excessively moist cigarette is more than moisture included in a normal cigarette, a temperature change in the second preheating drop period P33 may be set to be greater, and thus the initial hot feeling may be reduced.

In addition, in order to reduce the initial hot feeling, the second preheating period P3 may further include the third preheating maintenance period P34 in which the fifth target temperature T5 is maintained.

FIG. 10B is a flowchart illustrating an operating method of an aerosol generating device, according to another embodiment considering a humidity state of a cigarette.

The embodiment illustrated in FIG. 10B is different from the embodiment illustrated in FIG. 10A in which a humidity state of a cigarette is determined by using a temperature sensor, only in that the humidity state of the cigarette is determined by using a humidity detection sensor, and the other configurations are substantially the same. Hereinafter, redundant descriptions of the same components are omitted, and a difference therebetween is mainly described.

Referring to FIGS. 6 to 10B, the operating method of the aerosol generating device may include step S110 of heating the cigarette 2000 by using the heater 650, step S210 of measuring humidity of the cigarette 2000 by using the humidity detection sensor 628, step S310 of determining a humidity state of the cigarette 2000 by comparing the measured humidity of the cigarette 2000 with a preset threshold, steps S411 and S421 of selecting a temperature profile corresponding to the determined humidity state of the cigarette 2000, and step S510 of operating the heater 650 with the selected temperature profile.

Specifically, in step S210 of measuring the humidity of the cigarette 2000 by using the humidity detection sensor 628, the controller 610 may determine the humidity state of the cigarette 2000 by using the humidity detection sensor 628. According to an embodiment, the humidity detection sensor 628 may directly measure the amount of moisture included in the cigarette 2000 and provide the measured humidity information to the controller 610. For example, the humidity detection sensor 628 may be in the accommodation passage 1004h (in FIG. 7A) of the aerosol generating device 600. According to another embodiment, the humidity detection sensor 628 may measure the amount of moisture condensed around the cigarette after the cigarette 2 of FIG. 2 is heated. When heated, moisture evaporation of the excessively moist cigarette may be more than moisture evaporation of a normal cigarette. Due to this, when heated, dew condensation may occur more in the excessively moist cigarette than in the normal cigarette. For example, the humidity detection sensor 628 may be around the outer hole 1002p of FIG. 7A over lapping the accommodation passage 1004h (in FIG. 7A) of the aerosol generating device 600 or may be in the door 1003 of FIG. 7A.

The humidity detection sensor 628 may be any one of an electrical resistance sensor, a capacitance sensor, and an optical sensor. However, this is an example, and the humidity detection sensor 628 is not limited thereto.

In step S310 of determining the humidity state of the cigarette 2000 by comparing the measured humidity of the cigarette 2000 with the preset threshold, the controller 610 may determine the cigarette 2000 as a normal cigarette when the measured humidity of the cigarette 2000 is less than the threshold, and may determine the cigarette 2000 as an excessively moist cigarette when the measured humidity of the cigarette 2000 is greater than or equal to the threshold. In this case, the preset threshold may be the least humidity by which a user may feel hot due to the moisture included in the cigarette 2000 when the user inhales an aerosol.

In steps S411 and S421 of selecting a temperature profile corresponding to the determined humidity state of the cigarette 2000, the controller 610 may select the basic temperature profile TP when the measured humidity of the cigarette 2000 is less than the threshold, and may select the first correction profile CP1 when the measured humidity of the cigarette 2000 is greater than or equal to the threshold.

In step S510 of operating the heater 650 with the selected temperature profile, the controller 610 may supply power to the heater 650 according to the basic temperature profile TP when the measured humidity of the cigarette 2000 is less than the threshold, and may supply power to the heater 650 according to the first correction profile CP1 when the measured humidity of the cigarette 2000 is greater than or equal to the threshold.

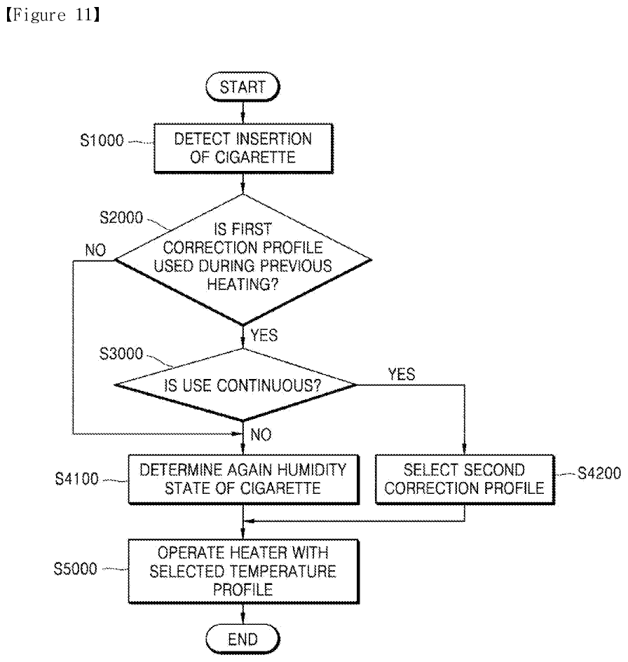

FIG. 11 is a flowchart illustrating an operating method of an aerosol generating device for determining whether a cigarette is continuously used. Hereinafter, redundant descriptions previously given with reference to FIGS. 8 to 10B are omitted.

Referring to FIGS. 6 to 11, the operating method of the aerosol generating device may include step S1000 of detecting insertion of the cigarette 2000 of FIG. 7A, step S2000 of checking whether the first correction profile CP1 was used when heating was made by the heater 650 immediately before, step S3000 of determining whether the heater 650 is continuously used, steps S4100 and S4200 of selecting a temperature profile corresponding to the determined continuous use state of the heater 650 and/or a humidity state of the cigarette 2000, and step S5000 of operating the heater 650 with the selected temperature profile.

Specifically, in step S1000 of detecting insertion of the cigarette 2000 of FIG. 7A, the controller 610 may detect the insertion of the cigarette 2000 by using the insertion detection sensor 624.

In step S2000 of checking whether the first correction profile CP1 was used when heating was made by the heater 650 immediately before, the controller 610 may check whether the first correction profile CP1 was used when heating was made by the heater 650 immediately before, on the basis of a temperature profile use history stored in the memory 670.

In step S3000 of determining whether the heater 650 is continuously used, the controller 610 may determine whether the heater 650 is being used continuously (or repeatedly). For example, the controller 610 may determine whether the heater 650 is being used continuously (or repeatedly) by using the temperature sensor 622 or by comparing an interval between an end of the previous smoking event and a start of the current smoking event with a preset time.

In steps S4100 and S4200 of selecting a temperature profile corresponding to the determined continuous use state of the heater 650 and/or the humidity state of the cigarette 2000, and in step S5000 of operating the heater 650 with the selected temperature profile, the controller 610 may determine again the humidity state of the cigarettes 2000 when it is determined that the use is not continuous. For example, the controller 610 may determine the humidity state of the cigarette 2000 by using the temperature sensor 622 or the humidity detection sensor 628. The controller 610 may supply power to the heater 650 according to the basic temperature profile TP when the cigarette 2000 is determined as a normal cigarette according to the humidity state of the cigarette 2000, and may supply power to the heater 650 according to the first correction profile CP1 when the cigarette 2000 is determined as an excessively moist cigarette according to the humidity state of the cigarette 2000. In addition, when it is determined that the use is continuous, the controller 610 may select the second correction profile CP2 and supply power to the heater 650 according to the second correction profile CP2.

In this way, the aerosol generating device 600 of the present disclosure may select a temperature profile corresponding to each of the humidity state and continuous use of the cigarette 2000, on the basis of the humidity state and/or the continuous use of the cigarette 2000 and may operate the heater 650 according to the selected temperature profile. Accordingly, the aerosol generating device 600 may reduce the hot feeling of main stream smoke and increase the amount of atomization.

Those of ordinary skill in the art related to the present embodiments may understand that various changes in form and details can be made therein without departing from the scope of the characteristics described above. Therefore, the disclosed methods should be considered in a descriptive point of view, not a restrictive point of view. The scope of the present disclosure is defined by the appended claims rather than by the foregoing description, and all differences within the scope of equivalents thereof should be construed as being included in the present disclosure.

1. An aerosol generating device comprising:
a heater configured to heat a cigarette;
a temperature sensor configured to measure a temperature of the heater; and
a controller configured to determine a humidity state of the cigarette by calculating a temperature increase time of the cigarette by using the temperature sensor and comparing the calculated temperature increase time of the cigarette with a preset threshold,
wherein the controller supplies power to the heater according to a basic temperature profile when the temperature increase time is less than the threshold, and supplies power to the heater according to a first correction profile when the temperature increase time is greater than or equal to the threshold.

2. The aerosol generating device of claim 1, wherein
the basic temperature profile includes a first preheating period and a first smoking period,
the first correction profile includes a second preheating period and a second smoking period, and
the second preheating period is longer than the first preheating period.

3. The aerosol generating device of claim 2, wherein
the first preheating period includes a first preheating increase period, a first preheating maintenance period, and a first preheating drop period,
the second preheating period includes a second preheating increase period, a second preheating maintenance period, a second preheating drop period, and a third preheating maintenance period, and
the first preheating increase period is shorter than the second preheating increase period.

4. The aerosol generating device of claim 3, wherein
the second preheating maintenance period is longer than the first preheating maintenance period, and
a temperature change in the second preheating drop period is greater than a temperature change in the first preheating drop period.

5. The aerosol generating device of claim 2, wherein
the first smoking period includes a first smoking drop period and a first smoking maintenance period, and
the second smoking period includes a second smoking maintenance period.

6. The aerosol generating device of claim 1, wherein, when insertion of the cigarette is detected, the controller determines whether the first correction profile was used during heating by the heater immediately before.

7. The aerosol generating device of claim 6, wherein, when it is determined that the first correction profile was used during the heating by the heater immediately before, the controller measures the temperature of the heater.

8. The aerosol generating device of claim 7, wherein
when the measured temperature of the heater is less than a reference temperature, the controller determines again the humidity state of the cigarette, and
when the measured temperature of the heater is higher than or equal to the reference temperature, the controller supplies power to the heater according to a second correction profile.

9. The aerosol generating device of claim 8, wherein
the first correction profile includes a second preheating period and a second smoking period,
the second correction profile includes a third preheating period and a third smoking period,
the second preheating period includes a second preheating increase period, a second preheating maintenance period, a second preheating drop period, and a third preheating maintenance period,
the third preheating period includes a third preheating increase period, a fourth preheating maintenance period, a third preheating drop period, and a fifth preheating maintenance period, and
a sum of the second preheating maintenance period, the second preheating drop period, and the third preheating maintenance period is greater than a sum of the fourth preheating maintenance period, the third preheating drop period, and the fifth preheating maintenance period.

10. The aerosol generating device of claim 6, wherein, when it is determined that the first correction profile was not used during heating by the heater immediately before, the controller determines again the humidity state of the cigarette.

11. An operating method of an aerosol generating device, the operating method comprising:
heating a cigarette by using a heater;
measuring a temperature of the heater by using a temperature sensor;
calculating a temperature increase time of the cigarette by using the temperature sensor;
comparing the calculated temperature increase time of the cigarette with a preset threshold;
determining a humidity state of the cigarette based on a result of the comparing; and
operating the heater with a temperature profile corresponding to the determined humidity state of the cigarette,
wherein, in the determining the humidity state of the cigarette, the cigarette is determined as a normal cigarette when the temperature increase time is less than the threshold, and the cigarette is determined as an excessively moist cigarette when the temperature increase time is greater than or equal to the threshold, and
in the operating the heater, power is supplied to the heater according to a basic temperature profile when the temperature increase time is less than the threshold, and the power is supplied to the heater according to a first correction profile when the temperature increase time is greater than or equal to the threshold.

12. The operating method of claim 11, wherein
the basic temperature profile includes a first preheating period and a first smoking period,
the first correction profile includes a second preheating period and a second smoking period, and
the second preheating period is longer than the first preheating period.

13. The operating method of claim 11, further comprising, when insertion of the cigarette is detected, determining whether the first correction profile was used during heating by the heater immediately before.

14. The operating method of claim 13, further comprising:
measuring the temperature of the heater when it is determined that the first correction profile was used during heating by the heater immediately before;
determining the humidity state of the cigarette again when the measured temperature of the heater is less than a reference temperature; and
supplying power to the heater according to a second correction profile when the measured temperature of the heater is higher than or equal to the reference temperature.

15. The operating method of claim 14, wherein
the first correction profile includes a second preheating period and a second smoking period,
the second correction profile includes a third preheating period and a third smoking period,
the second preheating period includes a second preheating increase period, a second preheating maintenance period, a second preheating drop period, and a third preheating maintenance period,
the third preheating period includes a third preheating increase period, a fourth preheating maintenance period, a third preheating drop period, and a fifth preheating maintenance period, and
a sum of the second preheating maintenance period, the second preheating drop period, and the third preheating maintenance period is greater than a sum of the fourth preheating maintenance period, the third preheating drop period, and the fifth preheating maintenance period.
